(19) United States
(12) Patent Application Publication
(10) Pub. No.: US 2026/0242997 A1
(43) Pub. Date: Aug. 20, 2026

(54) SYSTEMS AND METHODS FOR DETECTING AN UNBALANCED LOAD WITHIN A WASHING MACHINE APPLIANCE

(71) Applicant: Haier US Appliance Solutions, Inc., Wilmington, DE (US)

(72) Inventor: Cody Ewing, Floyds Knobs, IN (US)

(21) Appl. No.: 19/056,855

(22) Filed: Feb. 19, 2025

(51) Int. Cl. D06F 34/16; D06F 23/04; D06F 33/40; D06F 33/48; D06F 34/18; D06F 37/30; D06F 103/04; D06F 103/24; D06F 103/26; D06F 105/48; G01P 3/36; G01P 3/487

(52) U.S. Cl. CPC D06F 34/16; D06F 23/04; D06F 33/40; D06F 33/48; D06F 34/18; D06F 37/304; G01P 3/36; G01P 3/487; D06F 2103/04; D06F 2103/24; D06F 2103/26; D06F 2105/48

(57) ABSTRACT

A washing machine appliance may include a wash tub. The washing machine appliance may include a wash basket rotatably mounted within the wash tub. The washing machine appliance may include a motor mechanically coupled to the wash basket. The washing machine appliance may include a speed sensor assembly configured for obtaining a rotational velocity of the wash basket. The washing machine appliance may include a controller operably coupled to the motor. The controller may be configured for performing a wash operation. The wash operation may include directing the motor to rotate the wash basket according to a cleaning process; determining a rotational velocity of the wash basket during the cleaning process; determining, based on the rotational velocity, a rotational acceleration of the wash basket during the cleaning process; analyzing the rotational acceleration to identify an out-of-balance condition; and implementing a responsive action upon identifying the out-of-balance condition.

### FIELD OF THE DISCLOSURE

The present subject matter relates generally to a washing machine appliance and more particularly to systems and methods for operating a washing machine appliance.

### BACKGROUND OF THE DISCLOSURE

Washing machine appliances generally include a cabinet which supports a wash tub for containing wash fluid, e.g., wash water, detergent, bleach, or other wash additives. A wash basket is mounted within the wash tub and defines a wash chamber for receipt of articles for washing. During operation of such washing machine appliances, wash fluid is directed into the wash tub and onto articles within the wash chamber of the wash basket. The wash basket or an agitation element can rotate at various speeds to agitate articles within the wash chamber in the wash fluid. A spin cycle is often included after some cycles, for example at the end of a wash cycle or a rinse cycle. During the spin cycle, the wash basket spins at a high speed to urge wash fluid from articles within the wash chamber.

In some cases, an uneven distribution of weight during a spin cycle in a top load washing machine may cause excessive displacement of the wash tub and wash basket. In minor cases, a slight imbalance may cause vibration or noise. In extreme cases, the wash tub may contact the cabinet of the appliance. These impacts or “cabinet strikes” are noisy and can cause the washing machine to “walk” on the floor. Over time, the impacts can cause damage to the appliance.

Some known top load washing machines sense a load imbalance during a spin cycle by sensing vibration or cabinet strikes. The excessive vibrations and cabinet strikes that occur before the load imbalance is corrected can lead to consumer dissatisfaction or machine damage. Additionally, the machine may not reach the desired dehydration speed for an unbalanced load, resulting in a “wet load.” Notably, it can be difficult for modern washing machines to detect unbalanced loads and these loads can result in damage to the washing machine or its components if not detected and handled appropriately. Certain conventional methods for monitoring out-of-balance loads are costly and require complex sensors and software to process the sensor outputs.

Accordingly, systems and methods for detecting an unbalanced load of a washing machine appliance that obviates one or more of the abovementioned drawbacks would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a washing machine appliance is provided. The washing machine appliance may include a wash tub. The washing machine appliance may include a wash basket rotatably mounted within the wash tub. The washing machine appliance may include a motor mechanically coupled to the wash basket. The washing machine appliance may include a speed sensor assembly configured for obtaining a rotational velocity of the wash basket. The washing machine appliance may include a controller operably coupled to the motor. The controller may be configured for performing a wash operation. The wash operation may include directing the motor to rotate the wash basket according to a cleaning process. The wash operation may include determining a rotational velocity of the wash basket during the cleaning process. The wash operation may include determining, based on the rotational velocity, a rotational acceleration of the wash basket during the cleaning process. The wash operation may include analyzing the rotational acceleration to identify an out-of-balance condition. The wash operation may include implementing a responsive action upon identifying the out-of-balance condition.

In another exemplary aspect of the present disclosure, a method for detecting an unbalanced load within a washing machine appliance is provided. The washing machine appliance may include a wash tub, a wash basket rotatably mounted within the wash tub, a motor mechanically coupled to the wash basket, and a speed sensor assembly, The method may include directing the motor to rotate the wash basket according to a cleaning process; determining a rotational velocity of the wash basket during the cleaning process; determining, based on the rotational velocity, a rotational acceleration of the wash basket during the cleaning process; analyzing the rotational acceleration to identify an out-of-balance condition; and implementing a responsive action upon identifying the out-of-balance condition.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance matter with a lid in a closed position according to one or more exemplary embodiments of the present subject matter.

FIG. 2 provides a perspective view of the exemplary washing machine appliance of FIG. 1 with the lid in an open position according to one or more exemplary embodiments of the present subject matter.

FIG. 3 provides a side cross-sectional view of the exemplary washing machine appliance of FIG. according to one or more exemplary embodiments of the present subject matter.

FIG. 4 provides a plot illustrating rotational velocity of a wash basket across a spin cycle according to one or more exemplary embodiments of the present subject matter.

FIG. 5 provides a plot of illustrating rotational acceleration of a wash basket across a spin cycle according to one or more exemplary embodiments of the present subject matter.

FIG. 6 provides a method of detecting an out-of-balance condition in a washing machine appliance according to an example embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Embodiments of the present disclosure provide systems and methods for detecting an unbalanced load within a washing machine appliance. As will be appreciated in more detail below, the exemplary washing machine appliance utilizes a speed sensor assembly to measure or obtain rotational velocity of a wash basket, for instance, across a portion of the cleaning process, such as a spin cycle of the cleaning process. Based on the rotational velocity obtained with the speed sensor, a controller of the washing machine appliance may determine a rotational acceleration of the wash basket. Notably, the washing machine appliance is configured to detect an unbalanced load based on the obtained rotational acceleration. For instance, when the rotational acceleration of the wash basket drops below a predetermined acceleration threshold, the cleaning process may be immediately suspended. This may prevent or mitigate vibrations or cabinet strikes that can be caused by load imbalances. When compared to existing systems, for instance, systems that utilize accelerometers for measuring rotational acceleration, the exemplary systems and methods advantageously reduces cost and complexity of the washing machine appliance.

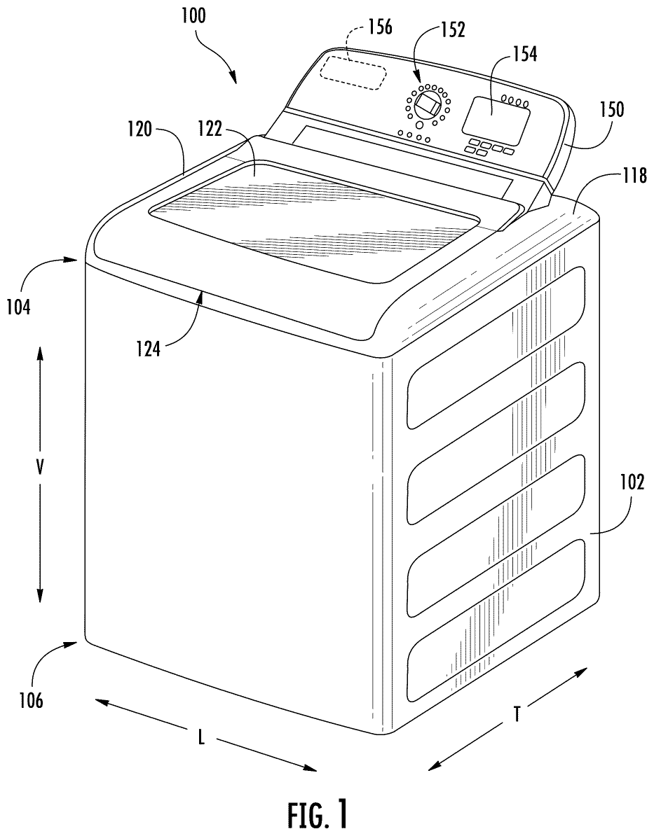

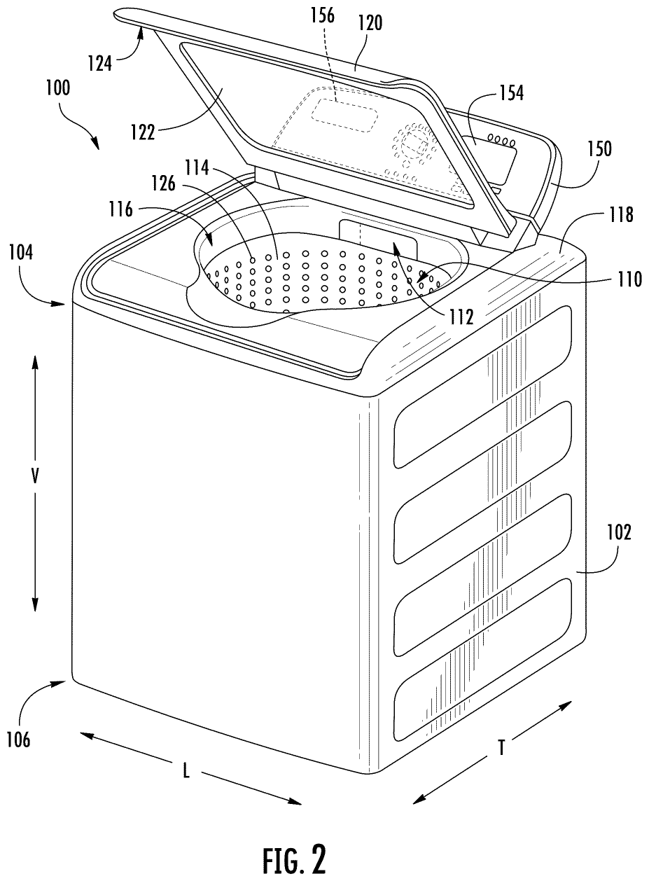

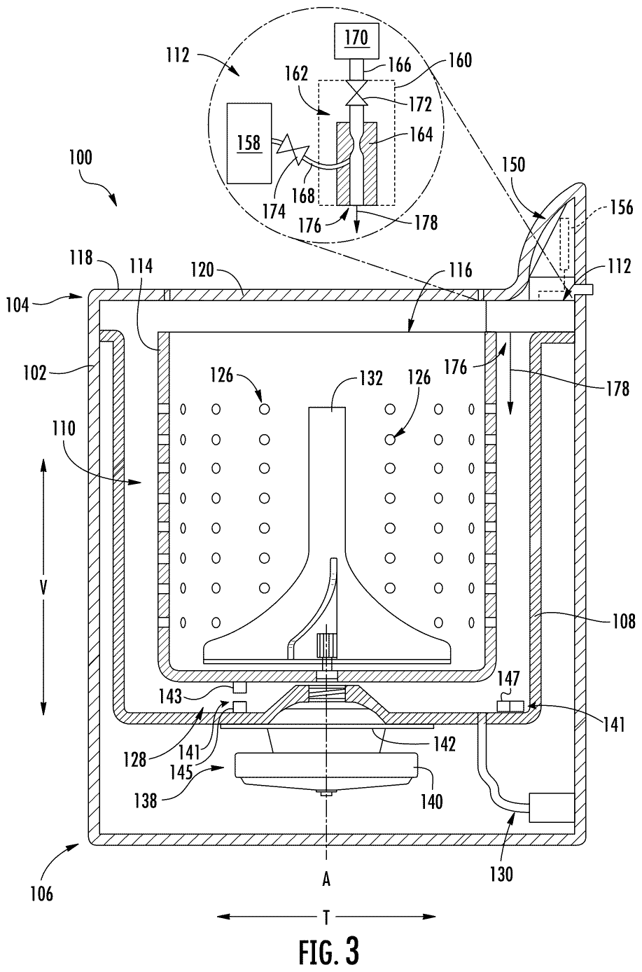

FIGS. 1 through 3 illustrate an exemplary embodiment of a vertical axis washing machine appliance 100. Specifically, FIGS. 1 and 2 illustrate perspective views of washing machine appliance 100 in a closed and an open position, respectively. FIG. 3 provides a side cross-sectional view of washing machine appliance 100. Washing machine appliance 100 generally defines a vertical direction V, a lateral direction L, and a transverse direction T, each of which is mutually perpendicular, such that an orthogonal coordinate system is generally defined.

While described in the context of a specific embodiment of vertical axis washing machine appliance 100, it should be appreciated that vertical axis washing machine appliance 100 is provided by way of example only. It will be understood that aspects of the present subject matter may be used in any other suitable washing machine appliance, such as a horizontal axis washing machine appliance. Indeed, modifications and variations may be made to washing machine appliance 100, including different configurations, different appearances, or different features while remaining within the scope of the present subject matter.

Washing machine appliance 100 may include a cabinet 102 that extends between a top portion 104 and a bottom portion 106 along the vertical direction V, between a first side (left) and a second side (right) along the lateral direction L, and between a front and a rear along the transverse direction T. As best shown in FIG. 3, a wash tub 108 may be positioned within cabinet 102. The wash tub 108 may define a wash chamber 110, and may generally be configured for retaining wash fluids during an operating cycle. Washing machine appliance 100 may further include a primary dispenser or dispensing assembly 112 (FIG. 2) for dispensing wash fluid into wash tub 108.

In addition, washing machine appliance 100 may include a wash basket 114 that may be positioned within wash tub 108. The wash basket may define an opening 116 for receipt of articles for washing. More specifically, wash basket 114 may be rotatably mounted within wash tub 108 such that the wash basket 114 may be rotatable about an axis of rotation A. According to the illustrated embodiment, the axis of rotation A is substantially parallel to the vertical direction V. In this regard, washing machine appliance 100 is generally referred to as a “vertical axis” or “top load” washing machine appliance 100. However, it should be appreciated that aspects of the present subject matter may be used within the context of a horizontal axis or front load washing machine appliance as well.

The cabinet 102 of washing machine appliance 100 may include a top panel 118. Top panel 118 may define an opening (FIG. 2) that coincides with opening 116 of wash basket 114 to permit a user access to wash basket 114. Washing machine appliance 100 may further include a door 120 which may be rotatably mounted to top panel 118 to permit selective access to opening 116. In particular, door 120 may selectively rotate between the closed position (as shown in FIGS. 1 and 3) and the open position (as shown in FIG. 2). In the closed position, the door 120 may inhibit access to wash basket 114. Conversely, in the open position, a user can access wash basket 114. A window 122 in door 120 may permit viewing of wash basket 114 when door 120 is in the closed position, e.g., during operation of washing machine appliance 100. Door 120 may also include a handle 124 that, e.g., a user may pull or lift when opening and closing door 120. Further, although door 120 is illustrated as mounted to top panel 118, door 120 may alternatively be mounted to cabinet 102 or any other suitable support.

The wash basket 114 may define a plurality of perforations 126 to facilitate fluid communication between an interior of wash basket 114 and wash tub 108. In this regard, wash basket 114 may be spaced apart from wash tub 108 to define a space for wash fluid to escape wash chamber 110. During a spin cycle, wash fluid within articles of clothing and within wash chamber 110 may be urged through perforations 126 wherein it may collect in a sump 128 defined by wash tub 108. Washing machine appliance 100 may include a pump assembly 130 (FIG. 3) that is located beneath wash tub 108 and wash basket 114 for gravity assisted flow when draining wash tub 108.

An impeller or agitation element 132 (FIG. 3), such as a vane agitator, impeller, auger, oscillatory basket mechanism, or some combination thereof is disposed in wash basket 114 to impart an oscillatory motion to articles and liquid in wash basket 114. More specifically, agitation element 132 may extend into wash basket 114 and assists agitation of articles disposed within wash basket 114 during operation of washing machine appliance 100, e.g., to facilitate improved cleaning. In different embodiments, agitation element 132 includes a single action element (e.g., oscillatory only), a double action element (oscillatory movement at one end, single direction rotation at the other end) or a triple action element (oscillatory movement plus single direction rotation at one end, single direction rotation at the other end). As illustrated in FIG. 3, agitation element 132 and wash basket 114 are oriented to rotate about axis of rotation A (which is substantially parallel to vertical direction V).

As best illustrated in FIG. 3, washing machine appliance 100 includes a drive assembly or motor assembly 138 in mechanical communication with wash basket 114 to selectively rotate wash basket 114 (e.g., during an agitation or a rinse cycle of washing machine appliance 100). In addition, motor assembly 138 may also be in mechanical communication with agitation element 132. In this manner, motor assembly 138 may be configured for selectively rotating or oscillating wash basket 114 or agitation element 132 during various operating cycles of washing machine appliance 100.

More specifically, motor assembly 138 may generally include one or more of a drive motor 140 and a transmission assembly 142, e.g., such as a clutch assembly, for engaging and disengaging wash basket 114 or agitation element 132. According to the illustrated embodiment, drive motor 140 is a brushless DC electric motor, e.g., a pancake motor. However, according to alternative embodiments, drive motor 140 may be any other suitable type or configuration of motor. For example, drive motor 140 may be an AC motor, an induction motor, a permanent magnet synchronous motor, or any other suitable type of motor. In addition, motor assembly 138 may include any other suitable number, types, and configurations of support bearings or drive mechanisms.

The washing machine appliance 100 may include a speed sensor assembly 141 for measuring or obtaining a rotational velocity (e.g., a speed) of the wash basket 114. The speed sensor assembly 141 may include one or more sensors configured for measuring or obtaining the rotational velocity of the wash basket as it rotates. For example, the speed sensor assembly 141 may include a magnet 143 coupled to the wash basket 114 and a hall effect sensor 145 coupled to the motor 140 at a location corresponding to the magnet 143. In such embodiments, as the wash basket 114 is rotated the hall effect sensor 145 “counts” the number of times the magnet passes by, thus providing real-time data that corresponds to a rotational velocity of the wash basket 114. As another example, the speed sensor assembly 141 may include an optical sensor 147 that may utilize light, such as an infrared light emitting diode and a photodiode to detect the speed of the rotating wash basket.

Referring still to FIGS. 1 through 3, a control panel 150 with at least one input selector 152 (FIG. 1) extends from top panel 118. Control panel 150 and input selector 152 may collectively form a user interface input for operator selection of machine cycles and features. A display 154 of control panel 150 indicates selected features, operation mode, a countdown timer, or other items of interest to appliance users regarding operation.

Operation of washing machine appliance 100 may be controlled by a controller or processing device 156 that may be operatively coupled to control panel 150 for user manipulation to select washing machine cycles and features. In response to user manipulation of control panel 150, controller 156 operates the various components of washing machine appliance 100 to execute selected machine cycles and features. According to an exemplary embodiment, controller 156 may include a memory and microprocessor, such as a general or special purpose microprocessor operable to execute programming instructions or micro-control code associated with methods described herein. Alternatively, controller 156 may be constructed without using a microprocessor, e.g., using a combination of discrete analog or digital logic circuitry (such as switches, amplifiers, integrators, comparators, flip-flops, AND/OR gates, or the like) to perform control functionality instead of relying upon software. Control panel 150 and other components of washing machine appliance 100 may be in communication with controller 156 via one or more signal lines or shared communication busses.

During operation of washing machine appliance 100, laundry items may be loaded into wash basket 114 through opening 116, and washing operation may be initiated through operator manipulation of input selectors 152. Wash basket 114 may be filled with water and detergent or other fluid additives via dispenser assembly 112. One or more valves may be controlled by washing machine appliance 100 to provide for filling wash tub 108 and wash basket 114 to the appropriate level for the amount of articles being washed or rinsed. By way of example for a wash mode, once wash basket 114 is properly filled with fluid, the contents of wash basket 114 can be agitated (e.g., with agitation element 132 as discussed previously) for washing of laundry items in wash basket 114.

After completion of the agitation cycle, washing machine appliance 100 may perform one or more rinse cycles. Specifically, according to an example embodiment, drain pump assembly 130 may drain the wash fluid from wash tub 108 and dispensing assembly 112 may dispense fresh water or a wash additive (such as fabric softener) into the wash tub. The load of clothes may then be agitated in the fresh water, e.g., to remove soil and detergent from load of clothes. After completion of the rinse cycle(s), drain pump assembly 130 may drain wash tub 108 and a spin cycle may be used to extract water from the clothes before the wash cycle is concluded.

Referring again to FIGS. 2 and 3, dispensing assembly 112 of washing machine appliance 100 will be described in more detail. As explained briefly above, dispensing assembly 112 may generally be configured to dispense wash fluid to facilitate one or more operating cycles or phases of an operating cycle (e.g., such as a wash cycle or a rinse cycle). The terms “wash fluid” and the like may be used herein to generally refer to a liquid used for washing or rinsing clothing or other articles. For example, the wash fluid is typically made up of water that may include other additives such as detergent, fabric softener, bleach, or other suitable treatments (including combinations thereof). More specifically, the wash fluid for a wash cycle may be a mixture of water, detergent, or other additives, while the wash fluid for a rinse cycle may be water only or additional rinse additives.

Optionally, dispensing assembly 112 may include a bulk storage tank or bulk reservoir 158 and a dispenser box 160. More specifically, bulk reservoir 158 may be positioned under top panel 118 and defines an additive reservoir for receiving and storing wash additive. More specifically, according to the illustrated embodiment, bulk reservoir 158 may contain a bulk volume of wash additive (such as detergent or other suitable wash additives) that is sufficient for a plurality of wash cycles of washing machine appliance 100, such as no less than twenty wash cycles, no less than fifty wash cycles, etc. As a particular example, bulk reservoir 158 is configured for containing no less than twenty fluid ounces, no less than three-quarters of a gallon, or about one gallon of wash additive.

As will be described in detail below, dispensing assembly 112 may include features for drawing wash additive from bulk reservoir 158 and mixing it with water prior to directing the mixture into wash tub 108 to facilitate a cleaning operation. By contrast, dispensing assembly 112 is also capable of dispensing water only. Thus, dispensing assembly 112 may automatically dispense the desired amount of water with or without a desired amount of wash additive such that a user can avoid filling dispenser box 160 with detergent before each operation of washing machine appliance 100.

For example, as best shown in FIG. 3, washing machine appliance 100 includes an aspirator assembly 162, which is a Venturi-based dispensing system that uses a flow of water to create suction within a Venturi tube to draw in wash additive from bulk reservoir 158 which mixes with the water and is dispensed into wash tub 108 as a concentrated wash fluid preferably having a target volume of wash additive. After the target volume of wash additive is dispensed into wash tub 108, additional water may be provided into wash tub 108 as needed to fill to the desired wash volume. It should be appreciated that the target volume may be preprogrammed in controller 156 according to the selected operating cycle or parameters, may be set by a user, or may be determined in any other suitable manner.

As illustrated, aspirator assembly 162 includes a Venturi pump 164 that is fluidly coupled to both a water supply conduit 166 and a suction line 168. As illustrated, water supply conduit 166 may provide fluid communication between a water supply source 170 (such as a municipal water supply) and a water inlet of Venturi pump 164. In addition, washing machine appliance 100 includes a water fill valve or water control valve 172 which is operably coupled to water supply conduit 166 and is communicatively coupled to controller 156. In this manner, controller 156 may regulate the operation of water control valve 172 to regulate the amount of water that passes through aspirator assembly 162 and into wash tub 108.

In addition, suction line 168 may provide fluid communication between bulk reservoir 158 and Venturi pump 164 (e.g., via a suction port defined on Venturi pump 164). Notably, as a flow of water is supplied through Venturi pump 164 to wash tub 108, the flowing water creates a negative pressure within suction line 168. This negative pressure may draw in wash additive from bulk reservoir 158. When certain conditions exist, the amount of wash additive dispensed is roughly proportional to the amount of time water is flowing through Venturi pump 164.

Referring still to FIG. 3, aspirator assembly 162 may further include a suction valve 174 that is operably coupled to suction line 168 to control the flow of wash additive through suction line 168 when desired. For example, suction valve 174 may be a solenoid valve that is communicatively coupled with controller 156. Controller 156 may selectively open and close suction valve 174 to allow wash additive to flow from bulk reservoir 158 through additive suction valve 174. For example, during a rinse cycle where only water is desired, suction valve 174 may be closed to prevent wash additive from being dispensed through suction valve 174. In some embodiments, suction valve 174 is selectively controlled based on at least one of the selected wash cycle, the soil level of the articles to be washed, and the article type. According to still other embodiments, no suction valve 174 is needed at all and alternative means for preventing the flow of wash additive may be used or other water regulating valves may be used to provide water into wash tub 108.

Washing machine appliance 100, or more particularly, dispensing assembly 112, generally includes a discharge nozzle 176 for directing a flow of wash fluid (e.g., identified herein generally by reference numeral 178) into wash tub 108. In this regard, discharge nozzle 176 may be positioned above wash tub 108 proximate a rear of opening 116 defined through top panel 118. Dispensing assembly 112 may be regulated by controller 156 to discharge wash fluid 178 through discharge nozzle 176 at the desired flow rates, volumes, or detergent concentrations to facilitate various operating cycles, e.g., such as wash or rinse cycles.

Although water supply conduit 166, water supply source 170, discharge nozzle 176, and water control valve 172 are all described and illustrated herein in the singular form, it should be appreciated that these terms may be used herein generally to describe a supply plumbing for providing hot or cold water into wash chamber 110. In this regard, water supply conduit 166 may include separate conduits for receiving hot and cold water, respectively. Similarly, water supply source 170 may include both hot-and cold-water supplies regulated by dedicated valves. In addition, washing machine appliance 100 may include one or more pressure sensors (not shown) for detecting the amount of water and or clothes within wash tub 108. For example, the pressure sensor may be operably coupled to a side of wash tub 108 for detecting the weight of wash tub 108, which controller 156 may use to determine a volume of water in wash chamber 110 and a subwasher load weight.

After wash tub 108 is filled and the agitation phase of the wash cycle is completed, wash basket 114 can be drained, e.g., by drain pump assembly 130. Laundry articles can then be rinsed by again adding fluid to wash basket 114 depending on the specifics of the cleaning cycle selected by a user. The impeller or agitation element 132 may again provide agitation within wash basket 114. One or more spin cycles may also be used as part of the cleaning process. In particular, a spin cycle may be applied after the wash cycle or after the rinse cycle in order to wring wash fluid from the articles being washed. During a spin cycle, wash basket 114 is rotated at relatively high speeds to help wring fluid from the laundry articles through perforations 126. During or prior to the spin cycle, drain pump assembly 130 may operate to discharge wash fluid from wash tub 108, e.g., to an external drain. After articles disposed in wash basket 114 are cleaned or washed, the user can remove the articles from wash basket 114, e.g., by reaching into wash basket 114 through opening 116.

During a portion of the exemplary cleaning process, such as during the spin cycle, the motor may be directed to rotate the wash basket 114 at a predetermined rotational acceleration. For example, the motor 140 may be directed to accelerate the wash basket 114 at a target rotational acceleration until the wash basket 114 is rotating at a desired speed. Typically, the motor 140 may be directed to accelerate the wash basket 114 for a predetermined amount of time, such as thirty seconds, forty five seconds, one minute, two minutes, or the like. If the load of articles within the wash basket 114 are unbalanced, the motor 140 may not be able to provide adequate power output to maintain the target rotational acceleration.

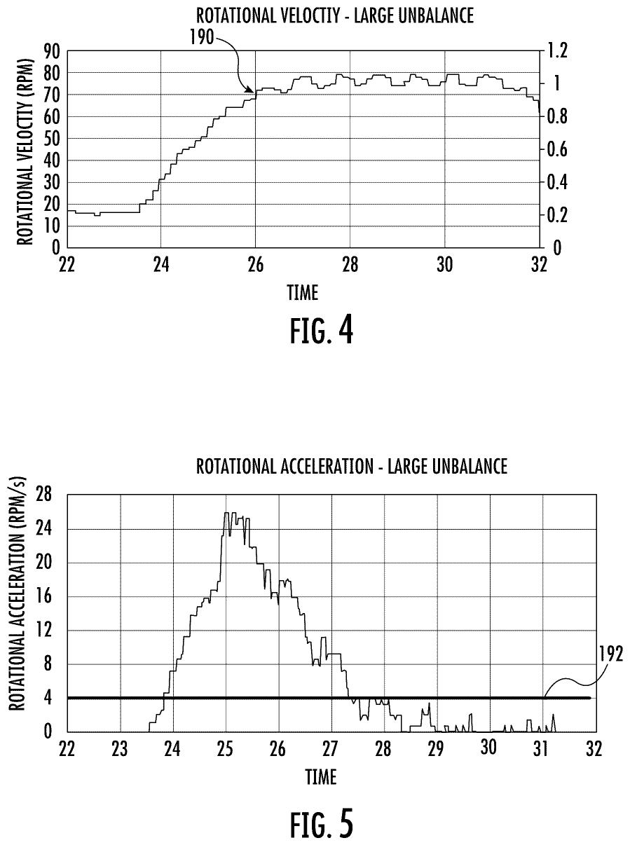

For example, referring now to FIG. 4, a plot illustrating rotational velocity of the wash basket 114 across a cleaning process is provided. In particular, the graph depicts rotational velocity of the wash basket (e.g., as measured by speed sensor assembly 141) across a cleaning process that is experiencing an out-of-balance condition. As described above, when there is a load of articles within the wash basket that is unbalanced, the motor may not be able to provide adequate power output to maintain the target rotational acceleration. In such instances, the rotational velocity (e.g., as measured by speed sensor assembly 141) may “stall” or remain relatively constant. For example, as may be shown by arrow 190, the measured rotational velocity of the exemplary cleaning process begins to stall at approximately twenty five seconds. This stalling of the measured velocity may correspond to a dropping of a rotational acceleration of the wash basket. For example, as may be seen in FIG. 5, a graph illustrating rotational acceleration of the wash basket across the cleaning process is provided. As may be seen, a drop in the rotational acceleration of the wash basket may begin at approximately 25 seconds.

If the rotational acceleration drops below a predetermined acceleration threshold, such as the acceleration threshold 192 (e.g., 4 RPM/s), it may be determined that the washing machine appliance is approaching, or passing through, its first natural frequency. As should be understood, the first natural frequency of the washing machine appliance may be a predetermined frequency at which vibrations exceed a predetermined threshold and cabinet strikes could occur. The first natural frequency may be based on the load size of articles within the wash basket or the target rotational acceleration (amongst other things). As will be appreciated in more detail below, the controller 156 may direct the motor 140 to halt rotation of the wash basket 114 when the rotational acceleration drops below the acceleration threshold 192. In this regard, excessive vibrations or cabinet strikes may advantageously be avoided. Notably, halting rotation of the wash basket when the obtained rotational acceleration drops below the acceleration threshold advantageously reduces or mitigates an amount of time the washing machine appliance spends at the first natural frequency, for instance, when compared to existing washing machine appliances that spend an exorbitant amount of time at the first natural frequency, thus resulting in cabinet strikes or excessive vibrations for many seconds at a time.

The rotational acceleration depicted in the graph may be obtained from, or based on, the rotational velocity measured from the speed sensor assembly 141. As should be appreciated, determining the rotational acceleration of the wash basket from the measured rotational velocity of the wash basket advantageously reduces cost and complexity of the washing machine appliance, for instance, when compared to washing machine appliances that may measure the acceleration of the washing machine appliance with built in accelerometers that may be costly and may require complex software to process the outputs of the accelerometer.

Now that the construction of washing machine appliance 100 and the configuration of controller 156 according to exemplary embodiments have been presented, an exemplary method 200 of operating a washing machine appliance will be described. Specifically, method 200 may be used to detect an out-of-balance condition in a washing machine appliance, such as the washing machine appliance 100. Although the discussion below refers to the exemplary method 200 of operating washing machine appliance 100, one skilled in the art will appreciate that the exemplary method 200 is applicable to the operation of a variety of other washing machine appliances, such as horizontal axis washing machine appliances. In exemplary embodiments, the various method steps as disclosed herein may be performed by controller 156 or a separate, dedicated controller.

At 210, the method 200 may include directing the motor to rotate the wash basket according to a cleaning process of the washing machine appliance. In particular, the cleaning process may include one or more spin cycles that may be applied after a wash cycle or after a rinse cycle in order to wring was fluid from the article being washed. In this regard, directing the motor to rotate the wash basket may include directing the motor according to one or more spin cycles. During the one or more spin cycles, the motor may be directed to rotate the wash basket at a target rotational acceleration until a target rotational velocity is achieved. For example, the motor may be directed to accelerate the wash basket at eight RPM/s until a target rotational velocity of the wash basket is achieved. Thus, the motor may rotate the wash basket at relatively high speeds to help wring fluid from laundry articles within the wash backet. During or prior to the one or more spin cycles, a drain pump assembly may operate to discharge wash fluid from the wash tub, for instance, to an external drain. may comprise a spin cycle of the washing machine appliance.

Optionally, the method 200 may include determining a load size of articles within the wash basket prior to directing the motor to rotate the wash basket according to the cleaning process. The load size of the articles may be determined by any suitable means or method. For example, the load size may be determined according to a current draw at the motor configured to rotate the laundry basket (or wash drum). The method 200 may include rotating the laundry basket at a predetermined revolutions per minute (RPM) for a predetermined amount or length of time. The current draw required to perform the rotation may be measured according to an attached sensor (e.g., a current sensor). As another example, the appliance may include a weight sensor. The weight sensor may be operably coupled with, or to, the laundry basket. Upon receiving the laundry load within the laundry basket, the weight sensor may detect, calculate, or otherwise determine the weight of the laundry load. For yet another example, a water pressure sensor may be operably connected with the appliance (e.g., with or at the laundry basket or wash tub). A pressure of the water within the system may thus be detected, calculated, or otherwise determined via the pressure sensor. The above methods are given by way of example, however, and it should be understood that any suitable manner of determining the load size of the laundry load may be incorporated.

At 220, the method 200 may include determining a rotational velocity of the wash basket during the cleaning process, such as during the one or more spin cycles of the cleaning process. In some embodiments, the rotational velocity of the wash basket is based on a motor power of the motor or a rotational speed obtained from a speed sensor assembly. Thus, 220 may include obtaining a motor power of the motor as it is spinning or rotating the wash basket. In this regard, the controller may be used to monitor power applied to the motor. According to alternative embodiments, other methods for determining motor power may be used while remaining within the scope of the present subject matter. Simultaneously, step 220 may include obtaining a basket speed of the wash basket. For instance, the basket speed of the wash basket may be obtained or measured with a speed sensor assembly, such as a magnet and hall-effect sensor, an optical sensor, or the like.

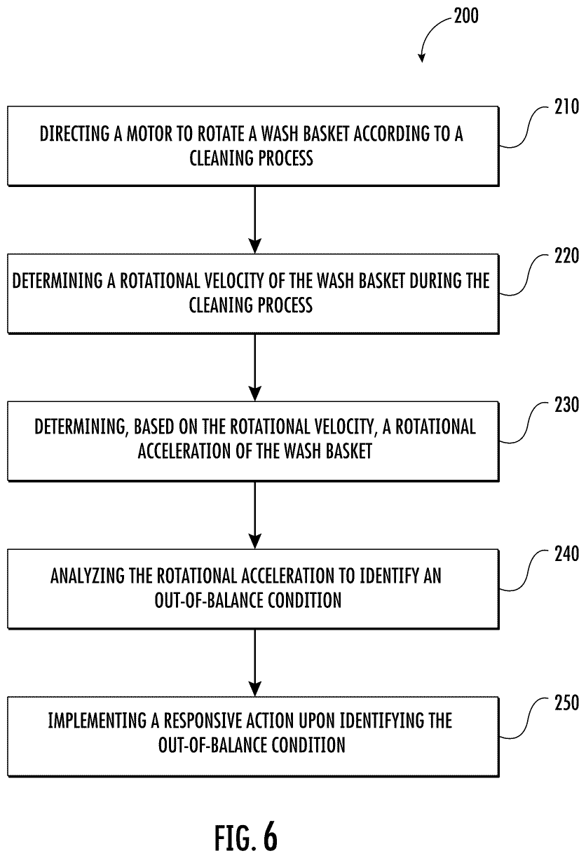

At 230, the method 200 may include determining, based on the rotational velocity (e.g., obtained at 220), a rotational acceleration of the wash basket. The rotational acceleration may correspond to a change in the rotational velocity (e.g., determined at 220) over a predetermined amount of time. For example, as illustrated in FIG. 6, a graph illustrating rotational acceleration of the wash basket over a predetermined period of time is provided. In some embodiments, the rotational acceleration is determined continuously throughout at least a portion of the cleaning process, such as throughout the one or more spin cycles.

At 240, the method 200 may include analyzing the rotational acceleration to identify an out-of-balance condition. In some embodiments, analyzing the rotational acceleration of the wash basket to identify an out-of-balance condition includes determining the rotational acceleration is below a predetermined acceleration threshold. In some embodiments, the predetermined acceleration threshold corresponds to a first natural frequency of the washing machine appliance. The first natural frequency of the washing machine appliance may be a predetermined frequency at which vibrations exceed a predetermined threshold and cabinet strikes could occur. The first natural frequency may generally be based on a load size of articles within the wash basket or the rotational velocity of the wash basket.

For example, the first natural frequency of the washing machine appliance may occur between about 10 and 90 revolutions per minute (RPM), between about 30 and 85 RPM, between about 40 and 80 RPM, or about 75 RPM. If the washing machine appliance begins to experience an out-of-balance condition, the motor may not be able to provide enough power to maintain the target rotational acceleration of the wash basket. For example, as illustrated in FIG. 5, a graph illustrating the rotational velocity of a wash basket experiencing a large out-of-balance condition is provided. As may be seen, if the imbalance of the load of articles is large enough, the motor may not be able to provide enough power to maintain a predetermined rotational acceleration. In this regard, the rotational velocity of the wash basket (e.g., determined at 220) may begin to “stall” or remain relatively constant. Thus, the rotational acceleration (e.g., that may be determined based on the obtained rotational velocity) may begin to decrease. For example, as illustrated in FIG. 6, as the rotational velocity of the wash basket stalls (e.g., as seen in FIG. 5), the rotational acceleration may decrease. When the rotational acceleration falls or drops below a predetermined acceleration threshold (e.g., 4 RPM/s as illustrated in FIG. 6), it may be determined that an out-of-balance condition is occurring.

Optionally, the rotational acceleration threshold may be adjusted based on user selected cycles or settings. For instance, in some embodiments, the method 200 includes receiving a user signal corresponding to one or more operational settings of the cleaning process. For example, a user may input one or more operational settings (e.g., load size, cycle time, cycle temperature, or the like) at the washing machine appliance, such as at the control panel of the washing machine appliance. In such embodiments, the predetermined acceleration threshold is based on the user signal. For example, the predetermined acceleration threshold may be raised or lowered based on user signal.

At 250, the method 200 may include implementing a responsive action upon or in response to identifying the out-of-balance condition. In some embodiments, implementing the responsive action includes directing the motor to halt rotation of the wash basket. For example, the controller may remove power to the controller, thus causing it to slow down. As another example, the controller may direct a bracket to apply a force to the motor to stop rotation of the motor. In this regard, when an out-of-balance condition is identified (e.g., based on the rotational acceleration), rotation of the wash basket may be stopped to prevent excessive vibration or cabinet strikes at the washing machine appliance. Additionally or alternatively, 250 may include performing a load redistribution procedure. For example, the load redistribution may include adding wash fluid to wash tub and re-agitating the load of clothes to improve the distribution. In addition, implementing the responsive action in response to identifying the out-of-balance condition may further include providing a user notification of the out-of-balance condition. For example, this user notification may be provided through a control panel, e.g., via a display of the control panel. According to still other embodiments, the user notification may be provided to a remote device (e.g., such as a user's cell phone) using a network. This user notification may include recommendations on rebalancing the load of clothes or other instructions for rectifying the out-of-balance condition.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance comprising:
a wash tub;
a wash basket rotatably mounted within the wash tub;
a motor mechanically coupled to the wash basket;
a speed sensor assembly configured for obtaining a rotational velocity of the wash basket; and
a controller operably coupled to the motor, the controller being configured for performing a wash operation, the wash operation comprising:
directing the motor to rotate the wash basket according to a cleaning process;
determining a rotational velocity of the wash basket during the cleaning process;
determining, based on the rotational velocity, a rotational acceleration of the wash basket during the cleaning process;
analyzing the rotational acceleration to identify an out-of-balance condition; and
implementing a responsive action upon identifying the out-of-balance condition.

2. The washing machine appliance of claim 1, wherein analyzing the rotational acceleration of the wash basket to identify an out-of-balance condition comprises
determining the rotational acceleration is below a predetermined acceleration threshold corresponding to a first natural frequency of the washing machine appliance.

3. The washing machine appliance of claim 2, further comprising:
receiving a user signal corresponding to one or more operational settings of the cleaning process,
wherein the predetermined acceleration threshold is based on the user signal.

4. The washing machine appliance of claim 1, wherein implementing the responsive action upon identifying the out-of-balance condition comprises
directing the motor to halt rotation of the wash basket.

5. The washing machine appliance of claim 4, wherein implementing the responsive action upon identifying the out-of-balance condition further comprises
directing one or more components of the washing machine appliance according to a load redistribution procedure in response to directing the motor to halt rotation.

6. The washing machine appliance of claim 1, wherein the speed sensor assembly comprises at least one of a magnet and hall-effect sensor or an optical sensor.

7. The washing machine appliance of claim 1, wherein the cleaning process comprises one or more spin cycles, and
wherein the rotational velocity is determined across the one or more spin cycles.

8. The washing machine appliance of claim 1, further comprising:
determining a load size of articles within the wash basket prior to directing the motor to rotate the wash basket,
wherein analyzing the rotational acceleration to identify an out-of-balance condition is based on the load size of articles within the wash basket.

9. The washing machine appliance of claim 1, wherein the rotational acceleration is determined continuously throughout the cleaning process.

10. The washing machine appliance of claim 1, wherein the cleaning process comprises one or more spin cycles.

11. A method for detecting an unbalanced load within a washing machine appliance, the washing machine appliance comprising a wash tub, a wash basket rotatably mounted within the wash tub, a motor mechanically coupled to the wash basket, and a speed sensor assembly, the method comprising:
directing the motor to rotate the wash basket according to a cleaning process;
determining a rotational velocity of the wash basket during the cleaning process;
determining, based on the rotational velocity, a rotational acceleration of the wash basket during the cleaning process;
analyzing the rotational acceleration to identify an out-of-balance condition; and
implementing a responsive action upon identifying the out-of-balance condition.

12. The method of claim 11, wherein analyzing the rotational acceleration of the wash basket to identify an out-of-balance condition comprises
determining the rotational acceleration is below a predetermined acceleration threshold corresponding to a first natural frequency of the washing machine appliance.

13. The method of claim 12, further comprising:
receiving a user signal corresponding to one or more operational settings of the cleaning process,
wherein the predetermined acceleration threshold is based on the user signal.

14. The method of claim 11, wherein implementing the responsive action upon identifying the out-of-balance condition comprises
directing the motor to halt rotation of the wash basket.

15. The method of claim 14, wherein implementing the responsive action upon identifying the out-of-balance condition further comprises
directing one or more components of the washing machine appliance according to a load redistribution procedure in response to directing the motor to halt rotation.

16. The method of claim 11, wherein the speed sensor assembly comprises at least one of a magnet and hall-effect sensor or an optical sensor.

17. The method of claim 11, wherein the cleaning process comprises one or more spin cycles, and
wherein the rotational velocity is determined across the one or more spin cycles.

18. The method of claim 11, further comprising:
determining a load size of articles within the wash basket prior to directing the motor to rotate the wash basket,
wherein analyzing the rotational acceleration to identify an out-of-balance condition is based on the load size of articles within the wash basket.

19. The method of claim 18, wherein the rotational acceleration is determined continuously throughout the cleaning process.

20. The method of claim 11, wherein the cleaning process comprises one or more spin cycles.
